(19) United States
(12) Patent Application Publication
(10) Pub. No.: US 2025/0249434 A1
(43) Pub. Date: Aug. 7, 2025

(54) METHOD TO FABRICATE NOVEL MAGNETIC ORGANIC FRAMEWORK MATERIAL FOR BARIUM COLLECTION FROM PRODUCED WATER

(71) Applicant: SAUDI ARABIAN OIL COMPANY, Dhahran (SA)

(72) Inventors: Jian Hou, Beijing (CN); Tianping Huang, Beijing (CN); Fahd Alghunaimi, Dhahran (SA); Norah Aljuryyed, Dhahran (SA); Tao Chen, Dhahran (SA)

(73) Assignees: SAUDI ARABIAN OIL COMPANY, Dhahran (SA); ARAMCO FAR EAST (BEIJING) BUSINESS SERVICES CO., LTD., Beijing (CN)

(21) Appl. No.: 18/693,911

(22) PCT Filed: Jan. 30, 2024
(86) PCT No.: PCT/CN2024/074649

§ 371 Date: Mar. 20, 2024

(51) Int. Cl. B01J 20/30; B01J 20/22; B01J 20/28; B01J 20/32; C02F 1/28; C02F 101/20; C02F 103/10

(52) U.S. Cl. CPC B01J 20/3085; B01J 20/226; B01J 20/28009; B01J 20/3078; B01J 20/3204; B01J 20/3219; B01J 20/3265; C02F 1/288; C02F 1/281; C02F 1/285; C02F 2101/20; C02F 2103/10; C02F 2305/08

(57) ABSTRACT

Methods for making a magnetic metal organic framework material include modifying a surface of a magnetic iron oxide nanoparticle, producing a modified magnetic iron oxide nanoparticle; adding a mixture of zirconium ions and aminoterephthalic acid to the modified magnetic iron oxide nanoparticle; growing a metal organic framework on the modified magnetic iron oxide nanoparticle with the mixture of zirconium ions and aminoterephthalic acid, thereby producing the magnetic metal organic framework material; heating the magnetic metal organic framework material; and treating the magnetic metal organic framework material.

### BACKGROUND

In oil and gas production processes, underground barium ions will be produced out with formation water. Barium concentrations in formation water may range from several parts per million (ppm) to thousands of ppm. Barium is a toxic element, and therefore, collection of barium from produced water is beneficial for reuse and recycling of produced waters.

The presence of sulfate ions in seawater often leads to scaling and formation damage in upstream oil and gas applications when combined with high concentrations of calcium, barium, or strontium, which are often found in formation waters. Current technologies used for removal of sulfates from seawater include reverse osmosis, nano-filtration, ion exchange and chemical precipitations. Among these technologies, chemical precipitations are cost-effective and efficient, and do not require a large energy input. In particular, precipitation with barium is an effective method used to remove sulfates. However, barium is a toxic and expensive element. Therefore, the acquisition of natural barium from formation waters is a sustainable and cost effective way to provide barium for such applications.

While various materials have been reported to adsorb barium from wastewaters, the adsorption capability of these materials is limited. Thus, there exists a continuing need to develop materials having greater adsorption capacities with a high selectivity towards barium, as compared to other cations present in high salinity produced water.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of making a magnetic metal organic framework material. The method may include modifying a surface of a magnetic iron oxide nanoparticle, producing a modified magnetic iron oxide nanoparticle; adding a mixture of zirconium ions and aminoterephthalic acid to the modified magnetic iron oxide nanoparticle; growing a metal organic framework on the modified magnetic iron oxide nanoparticle with the mixture of zirconium ions and aminoterephthalic acid, thereby producing the magnetic metal organic framework material; heating the magnetic metal organic framework material; and treating the magnetic metal organic framework material.

In another aspect, embodiments disclosed herein relate to other methods of making a magnetic metal organic framework material. The methods may include preparing a magnetic iron oxide nanoparticle; modifying a surface of the magnetic iron oxide nanoparticle with citric acid, producing a modified magnetic iron oxide nanoparticle functionalized with a carboxylic acid; adding a mixture of zirconium ions and aminoterephthalic acid to the modified magnetic iron oxide nanoparticle, wherein the zirconium ions are selected from a group consisting of Zr(SO₄)₂·4H₂O, ZrOCl₂·8H₂O, and combinations thereof and wherein the zirconium ions and aminoterephthalic acid are present in a molar ratio ranging from 1:2 to 2:1; growing a metal organic framework on the modified magnetic iron oxide nanoparticle with the mixture of zirconium ions and aminoterephthalic acid, producing the magnetic metal organic framework material; heating the magnetic metal organic framework material; and treating the magnetic metal organic framework material, wherein treating comprises washing immersing and incubating with sulfuric acid in a concentration ranging from 1% v/v to 5% v/v, thereby adding a sulfate to the magnetic metal organic framework material.

Other aspects and advantages of the claimed subject matter will be apparent from the following description and the appended claims.

### BRIEF DESCRIPTION OF DRAWINGS

FIG. 1 shows the chemical structure of a magnetic metal organic framework material according to one or more embodiments.

FIG. 2 is a flowchart for a method of making a magnetic metal organic framework material according to one or more embodiments.

FIG. 3 is a schematic for a method of making a magnetic metal organic framework material according to one or more embodiments.

FIG. 4 is a transmission electron microscope image of the modified iron oxide nanoparticles according to one or more embodiments.

FIG. 5 is a transmission electron microscope image of the metal organic framework material according to one or more embodiments.

### DETAILED DESCRIPTION

In one aspect, embodiments disclosed herein relate to methods of making a magnetic metal organic framework (MOF). MOFs have shown high adsorption capabilities towards cations. MOFs may be designed by the addition of different functional groups to tailor selectively towards a target chemical species. The selectivity towards certain chemical species is especially important when using MOFs in oilfield applications, where formation waters often contain high salinity and/or high concentrations of ionic species other than the target species.

Embodiments disclosed herein describe methods for preparing a novel magnetic metal organic framework material which may be used to effectively adsorb and collect barium from water, in the absence or presence of high salinity and other ions such as calcium and magnesium which are commonly found in produced water. In detail, the method may include preparing a magnetic iron oxide nanoparticle by modifying a surface of the magnetic oxide nanoparticle. The modified magnetic iron oxide nanoparticle may be added to a mixture of zirconium ions and aminoterephthalic acid where a MOF may be grown on the surface, producing a magnetic MOF material. The method may include heating and treating the magnetic MOF material to produce a novel magnetic organic framework material that may adsorb and collect barium from water.

### Magnetic Metal Organic Framework Material Composition

In one aspect, embodiments disclosed herein relate to a magnetic MOF material composition for barium collection. The magnetic MOF material composition for barium collection includes a core and a MOF, where the MOF may be disposed on the surface of the core as a coating. The core of the magnetic MOF material composition for barium collection may be a magnetic metal oxide nanoparticle. The MOF may include a transition metal, an organic ligand, and an inorganic ion The organic ligand may be chemically bonded to the transition metal.

In one or more embodiments, the size of the magnetic MOF material composition for barium collection is about 10 nm to 30 nm. For example, the size of the magnetic MOF material composition for barium collection may be in a range having a lower limit of any one of 100, 1000, and 2500 nm and an upper limit of any one of 3000, 4000, and 5000 nm, where any lower limit may be paired with any upper limit.

In one or more embodiments, the average pore size of the magnetic MOF material composition for barium collection is about 5 Å to 10 Å. For example, the pore size of the magnetic MOF material composition for barium collection may be in a range having a lower limit of any one of 5, 5.5, 6, 6.5, and 7 Å and an upper limit of any one of 7.5, 8, 8.5, 9, 9.5, and 10 Å, where any lower limit may be paired with any mathematically compatible upper limit.

In one or more embodiments, the surface area of the magnetic MOF material composition for barium collection is greater than 100 m²/g. For example, the surface area of the magnetic MOF material composition for barium collection may be greater than 100 m²/g, greater than 500 m²/g, or greater than 1000 m²/g.

As defined herein, “saturation adsorption capacity” refers to a measure of the maximum capacity of adsorbate that an adsorbent can hold. Below the saturation adsorption capacity, the adsorption amount depends on an initial concentration of adsorbate and adsorbent. In general, a fixed amount of adsorbent will adsorb more adsorbate from a solution when more adsorbate is initially present in the solution. At a certain concentration of adsorbate, the amount of adsorbate which can be adsorbed by the fixed amount of adsorbent, will reach a plateau, thereby reaching the saturation adsorption capacity.

In one or more embodiments, the magnetic MOF material composition for barium collection has a saturated adsorption capacity toward barium of at least 500 mg/g. For example, the magnetic MOF material composition for barium collection may have a saturated adsorption capacity toward barium of 500 mg/g, 1000 mg/g, 2000 mg/g, of 5,000 mg/g.

In one or more embodiments, the core in the magnetic MOF material composition for barium collection is a magnetic metal oxide. The magnetic metal oxide may be iron oxide as magnetite (Fe₃O₄), iron oxide as maghemite (γ-Fe₂O₃), other ferrite materials composed of Fe₂O₃, and combinations thereof. The other ferrite materials composed of Fe₂O₃may include barium oxide (BaO), strontium oxide (SrO), cobalt (Co), lanthanum (La), manganese oxide, zinc oxide, or nickel oxide.

The magnetic metal oxide of one or more embodiments is a nanoparticle. In one or more embodiments, the size of the magnetic metal oxide is about 10 nm to 30 mm. For example, the size of the magnetic metal oxide may be in a range having a lower limit of any one of 10, 15, and 20 nm and an upper limit of any one of 25 and 30 nm, where any lower limit may be paired with any upper limit.

In one or more embodiments, the MOF included in the magnetic MOF material composition for barium collection includes a transition metal, an organic ligand, and an inorganic ion. The organic ligand may be chemically bonded to the transition metal.

In one or more embodiments, the MOF includes at least one transition metal. The transition metal may be selected from the group consisting of zirconium (Zr) or chromium (Cr).

In one or more embodiments, the MOF includes an organic ligand. The organic ligand may be selected from the group consisting of aminoterephthalic acid (BDC-NH₂), terephthalic acid (BDC), 1,3,5-benzenetricarboxylic acid, 2-mercaptomalic acid, meso-dimercaptosuccinic acid, and piperazine-1,4-dicarboxylic acid.

In one or more embodiments, the MOF includes an inorganic ion. The inorganic ion may be sulfate (SO₄²⁻). The sulfate may be from sulfuric acid, Zr(SO₄)₂, or Na₂SO₄. The sulfate may coordinate to barium ions so that the MOF may adsorb the barium ions from water.

In one or more embodiments, the organic ligand is chemically bonded to the transition metal. The chemical bonding of the organic ligand to the transition metal may form secondary building units (SBU). The SBU may be arranged into square, hexagonal, or diamond clusters.

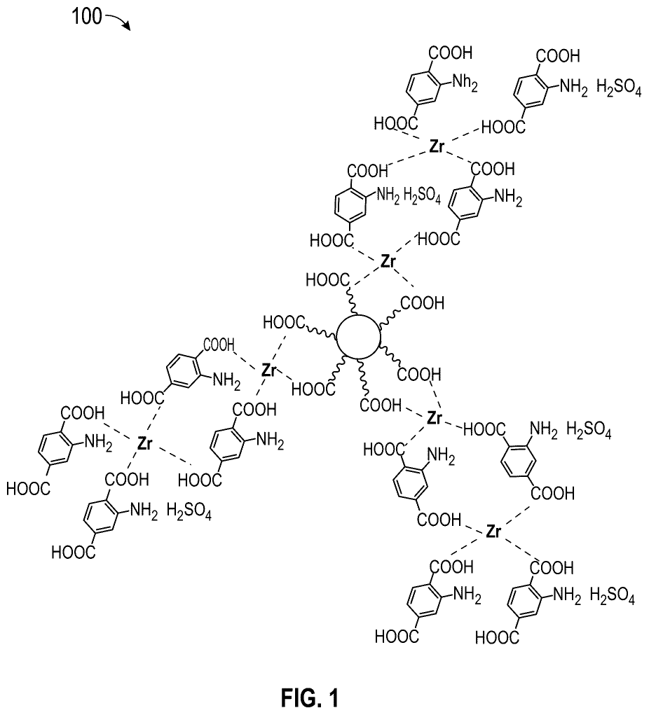

In one or more embodiments, the MOF is disposed on the surface of the core as a coating in the magnetic MOF material composition for barium collection. Zirconium is linked to the iron oxide surface though coordination with a carboxylic group. Citric acid, sodium citrate, or humic acid may be used to modify the surface of the iron oxide with the carboxylic group during the synthesis of the iron oxide. Additionally, mercaptoacetic acid or mecaptopropionic acid may be used to modify the surface of the non oxide after the synthesis via incubation. FIG. 1 shows a chemical structure 100 of the magnetic MOF material composition for barium collection according to one or more embodiments.

### Method for Making a Magnetic Metal Organic Framework Material

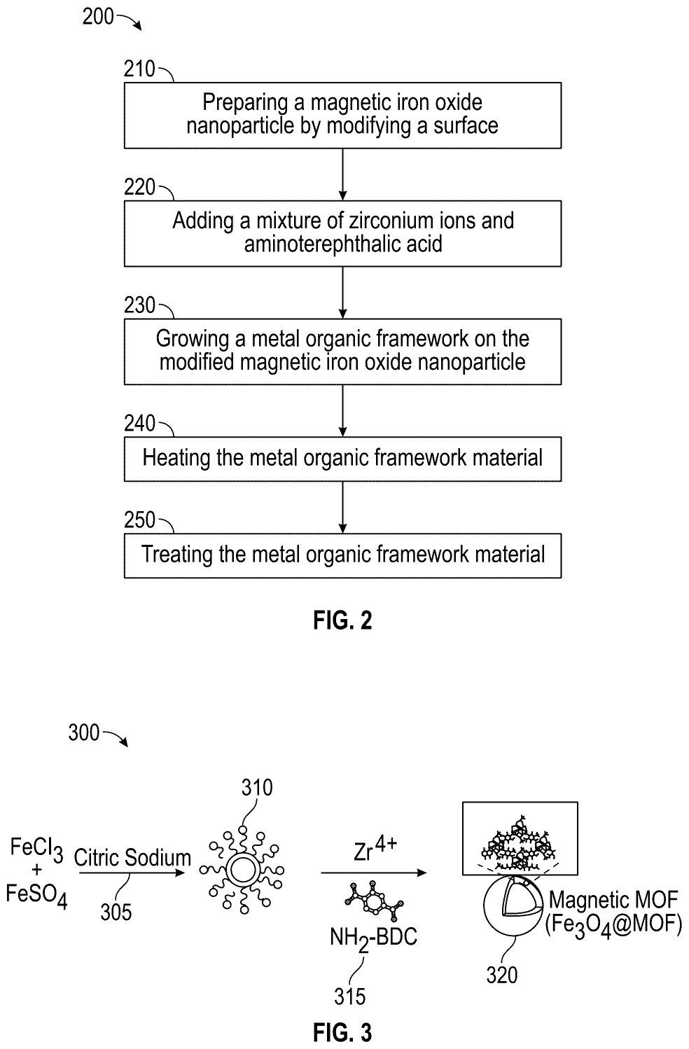

In one aspect, embodiments described herein relate to methods for making a magnetic metal organic framework (MOF) material. The method 200 is depicted in a flowchart in FIG. 2 as well as in a schematic 300 in FIG. 3.

The method 200 includes preparing the magnetic metal oxide nanoparticle at block 210. Preparing the magnetic iron oxide nanoparticle may include co-precipitation of iron ions in the presence of a base. Co-precipitation may occur in a solvent. The solvent may be water, such as deionized water. In one or more embodiments, the iron ions are Fe²⁺ and Fe³⁺. The iron ions may be from any water soluble iron salt. For example, Fe²⁺ may be from ferrous sulfate heptahydrate (FeSO₄·7H₂O) and Fe³⁺ may be from ferric chloride hexahydrate (FeCl₃·6H₂O). The iron ions may have a molar ratio of Fe²⁺ to Fe³⁺ that is in a range from 0.25 to 1. Co-precipitation may include first heating the iron ions in an oil bath at a temperature ranging from about 60° C. to about 150° C. The iron ions may be heated in the oil bath for a period ranging from 15 minutes to 120 minutes.

Co-precipitation may include adding a base after the iron ions are heated. In one or more embodiments, the base may be ammonia. The ammonia may be diluted in water to form ammonium hydroxide where the concentration of the ammonium hydroxide is 25 wt %. The overall concentration of the diluted ammonium hydroxide during co-precipitation may be in a range of 5 to 15 vol %. The base may be added to the iron ions while heating in the oil bath at a temperature range of 80° C. to 120° C. After adding the base, the mixture of iron ions and base may be stirred for a period ranging from 15 minutes to 120 minutes. The mixture of iron ions and base may be stirred by mechanical stirring. During co-precipitation, the base reduces the iron ions to produce magnetic iron oxide (Fe₃O₄) nanoparticles in the form of brown precipitates. After co-precipitation, the magnetic iron oxide nanoparticles may be cooled to room temperature (i.e., about 25° C.) then washed by centrifugation and deionized water to remove any unreduced iron ions remaining.

Preparing the magnetic iron oxide nanoparticle may further include modifying the surface of the magnetic iron oxide nanoparticle. During co-precipitation, the surface may be modified with carboxylic acid from citric acid, sodium citrate, or humic acid. The carboxylic acid may further act as a capping agent during co-precipitation. As a capping agent, the carboxylic acid may result in iron oxide nanoparticles with an average size of 10 to 20 nanometers. The citric acid, sodium citrate, or humic acid may be added during co-precipitation with the mixture of the iron ions and the base, as shown by arrow 305 in FIG. 3. The citric acid, sodium citrate, or humic acid may be added at an overall concentration in the range of 0.2 g/100 mL to 0.8 g/100 mL. Citric acid may be added as an aqueous solution. The aqueous citric acid solution may have a concentration that is greater than the overall concentration added during modification. As such, the aqueous citric acid solution may have a concentration of 0.4 g/100 mL to 1.6 g/100 mL. Citric acid, sodium citrate, or humic acid may functionalize the surface of the magnetic iron oxide nanoparticle with carboxylic acid, thus forming a modified magnetic iron oxide nanoparticle 310 as shown in FIG. 3.

The method 200 includes adding a mixture of zirconium ions and aminoterephthalic acid (as shown by block 220 in FIG. 2 and by arrow 315 in FIG. 3) to the modified magnetic iron oxide nanoparticle. The zirconium ions may be from any water soluble zirconium salt. For example, the zirconium ions may be from Zr(SO₄)₂·4H₂O, ZrOCl₂·8H₂O, and combinations thereof. The aminoterephthalic acid may be supplied by Sigma-Aldrich, Acros Organics, TCI, Shanghai Macklin Biochemical Co., Alfa Aesar, Aladdin Scientific, Yuanye Chemical Co., Leyan, or J&K Scientific. The mixture of zirconium ions and aminoterephthalic acid may be added to the modified magnetic iron oxide nanoparticles at a molar ratio of zirconium ions to aminoterephthalic acid ranging from 1:2 to 2:1. The overall concentration of the zirconium ions may be in a range of 0.1 M to 0.3 M. The overall concentration of the modified iron oxide nanoparticles may be in a range of 5 g/L to 1.5 g/L. The mixture of zirconium ions, aminoterephthalic acid, and modified magnetic iron oxide nanoparticles may include a solvent. The solvent may be deionized water.

The method 200 then includes growing a MOF on the modified magnetic iron oxide nanoparticle at block 230. Growing a MOF may include a hydro-thermal method where a mixture of zirconium ions and aminoterephthalic acid with modified iron oxide nanoparticles is heated in an oil bath to a temperature ranging from 90° C. to 110° C. Growing the MOF may occur over a time period ranging from 12 hours to 24 hours. While growing the MOF, the mixture of zirconium ions, aminoterephthalic acid, and modified magnetic iron oxide nanoparticles may be stirred by mechanical stirring. The hydro-thermal method of growing the MOF may result in the carboxylic acids on the surface of the modified magnetic iron oxide nanoparticles reacting with the zirconium ions. The zirconium ions may further react with aminoterephthalic acid such that a Zr-BDC-NH2 MOF will grow on the modified magnetic iron oxide nanoparticle surface. After growing the MOF is completed, the produced magnetic MOF material 320, as shown in FIG. 3, is separated by centrifugation and washed with water and methanol to remove any unreacted zirconium ions, aminoterephthalic acid, or modified magnetic iron oxide nanoparticles

The method 200 includes heating a magnetic MOF material at block 240. Heating the magnetic MOF material after growing may remove the solvent. Heating the magnetic MOF material after growing may also stabilize the structure of the magnetic MOF material. By removing the solvent, the heating may result in rigid bonds within the magnetic MOF material, thereby stabilizing the structure. Heating may occur at a temperature ranging from 110° C. to 200° C. Heating may occur for a time period ranging from 12 hours to 24 hours.

The method 200 includes treating the magnetic MOF material at block 250. Treating the magnetic MOF material may include immersing and incubating the magnetic MOF material in sulfuric acid. Immersing and incubating the magnetic MOF material with sulfuric acid may add a sulfate to the MOF structure. The sulfate may impact the geometry and pore size of the magnetic MOF material. The geometry of the magnetic MOF material may be similar to a diamond geometry. The addition of the sulfate may change the diamond geometry due to static force or steric hinderance. The addition of the sulfate may reduce the pore size of the magnetic MOF material. The sulfate may be used to complex barium ions from water. The addition of the sulfate may result in crystal restoration. Crystal restoration may occur from an interaction between the sulfuric acid and the NH₂ groups of aminoterephthalic acid. The interaction may be electrostatic. The sulfuric acid may be an aqueous solution with a concentration ranging from 1% (v/v) to 5% (v/v). Immersing and incubating the magnetic MOF material with sulfuric acid may occur in an oven at a temperature ranging from 110° C. to 200° C. Immersing and incubating the magnetic MOF material with sulfuric acid may occur over a time period ranging from 12 hours to 24 hours.

After treating, the magnetic MOF material may be cooled to room temperature (i.e., about 25° C.), washed with water and methanol, and dried. Washing may occur by agitating the magnetic MOF material in water first and then in methanol. Drying may occur in air at a temperature of at least 40° C. The temperature may range up to no greater than 150° C. Drying may occur over a period of at least 12 hours.

### Method for Barium Collection

Embodiments disclosed herein also relate to a method for barium collection. The method for barium collection may include making a magnetic MOF material for barium collection, mixing the magnetic MOF material with a water source, and adsorbing, using the magnetic MOF material, an amount of barium from the water source.

The method for barium collection, according to one or more embodiments, includes making a magnetic MOF material. As previously described, the method for making a magnetic MOF material may include preparing a magnetic iron oxide nanoparticle, adding a mixture of zirconium ions and aminoterephthalic acid, growing a MOF, heating the magnetic MOF material, and treating the magnetic MOF material.

The method for barium collection also includes mixing the magnetic MOF material for barium collection with a water source. Such mixing may include techniques to agitate the admixture, including mechanical mixers or use of an injected flow of air to make a vortex in the admixture. The amount of composition added to the water source may be selected depending on the barium content of the water source and the saturation adsorption capacity toward barium of the composition For example, the concentration of the composition for barium collection in the water source may range from 0 to 10,000 ppm.

The method for barium collection also includes adsorbing, using the magnetic MOF material, an amount of barium from the water source to produce a barium-adsorbed composition and a resultant solution. Such adsorption may occur through adequate exposure of the composition to the water source containing barium.

Following adsorption of the barium into the composition, the barium-adsorbed composition may be separated from the resultant solution through the use of magnets. As mentioned above, the core of the composition for barium collection includes a magnetic particle, and thus, application of a magnetic force, whether by directly exposing a magnetic material to the admixture so that the barium-adsorbed composition is attracted to the magnetic material or by applying a magnetic force to a vessel containing the admixture as the resultant solution is drained from the vessel, may allow for the separation of the barium-adsorbed composition from the resultant solution (having a lower barium content than the water source).

In some embodiments, the method for barium collection further includes delivering, using a delivery line fluidly connected to a delivery system, the magnetic MOF material to the water source, separating, using magnetic force, the barium-adsorbed magnetic MOF material from the resultant solution, and collecting, using a collection line fluidly connected to a collection system, the barium-adsorbed magnetic MOF material, where the delivery system is fluidly connected to the water source via the delivery line and the collection system is fluidly connected to the water source via the collection line.

In some embodiments, the water source has a total dissolved solids concentration in a range of from about 0 ppm to about 100,000 ppm. For example, the TDS of the water source may be in a range having a lower limit of any one of 0, 100, 1,000, and 10,000 ppm and an upper limit of any one of 10,000, 25,000, 50,000 and 100,000 ppm, where any lower limit may be paired with any upper limit.

In one or more embodiments, the water source has a high concentration of barium ions. For example, the water source may include barium ions in a concentration ranging from about 1 to about 5,000 ppm.

In one or more embodiments, the water source has a concentration of calcium ions in a range of from about 0 ppm to about 5,000 ppm. For example, the concentration of calcium ions in the water source may be in a range having a lower limit of any one of 0, 100, and 1,000 ppm and an upper limit of any one of 2,000, 4,000, and 5,000 ppm, where any lower limit may be paired with any upper limit.

In one or more embodiments, the water source has a concentration of magnesium ions in a range of from about 0 ppm to about 1,000 ppm. For example, the concentration of calcium ions in the water source may be in a range having a lower limit of any one of 0, 100, and 500 ppm and an upper limit of any one of 600, 750 and 1,000 ppm, where any lower limit may be paired with any upper limit.

In some embodiments, the water source has a concentration of calcium ions in a range of from about 1 to about 5,000 ppm and a concentration of magnesium ions in a range of from about 1 to about 1,000 ppm.

The magnetic MOF material of one or more embodiments may have a saturation adsorption capacity toward barium of at least 500 mg/g. For example, in embodiments where the water source contains any range of TDS, including 0 ppm (i.e., deionized water) and when the water source has a concentration of calcium ions in a range of from about 1 to about 5,000 ppm and a concentration of magnesium ions in a range of from about 1 to about 1,000 ppm, the saturation capacity toward barium of the magnetic MOF material remains at least 500 mg/g. In other words, the saturation capacity toward barium of the magnetic MOF material is not negatively affected by the presence of other ions, such as magnesium, calcium, or the like in the water source.

Embodiments of the present disclosure may provide at least one of the following advantages. The barium loading and adsorption efficiency of the magnetic MOF material are much higher than commercially available alternatives. In addition, barium selectivity of the magnetic MOF material of one or more embodiments in high salinity water is superior to commercially available alternatives. Commercially available alternatives will adsorb calcium or magnesium, and the barium adsorption efficiency is generally very low in high salinity water. But the adsorption capacity of barium using the magnetic MOF material of one or more embodiments is not affected by the salinity of water. Additionally, the hydro-thermal method of making the magnetic MOF material may be more convenient as compared to a layer-by-layer method.

### EXAMPLES

### Example 1 Preparation of Fe₃O₄@Zr-BDC-NH₂SO₄

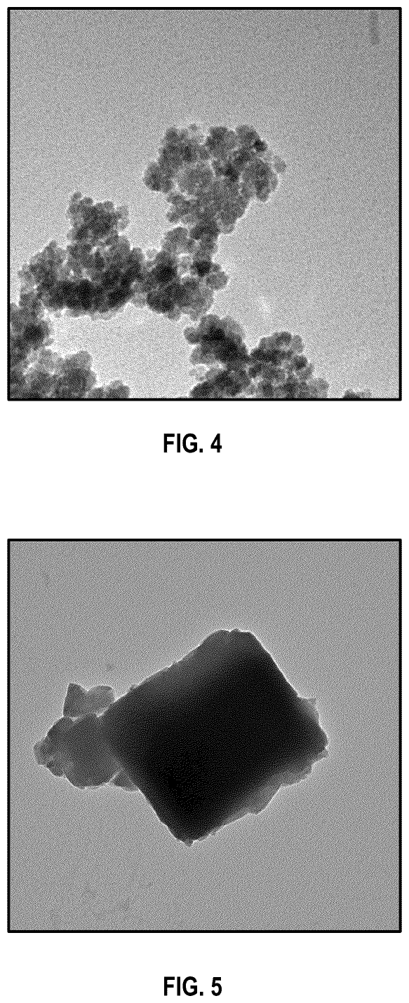

In the first step, Fe₃O₄ nanoparticles with carboxylic modified surface were synthesized, 6.1 grams of ferric chloride hexahydrate (FeCl₃·6H₂O) and 4.2 grams of ferrous sulfate heptahydrate (FeSO₄·7H₂O) were dissolved in 100 mL deionized water and heated to 90° C. (within half an hour in a small oil bath). Then 10 mL of ammonium hydroxide (25%) and 0.5 grams citric acid dissolved in 50 mL deionized water was added. The mixture was stirred at 90° C. for 30 minutes and then cooled to room temperature. The brown precipitates were collected after centrifugation of colloidal solution at 8,000 rpm and washed with water three times. An example transmission electron microscope (TEM) image of the Fe₃O₄ nanoparticles with a carboxylic modified surface is shown in FIG. 4.

The second step is the synthesis of the Fe₃O₄@Zr-BDC-NH₂-SO₄. 2-aminoterephthalic acid (2.400 grams, 13.3 mmol) and zirconium sulfate tetrahydrate, Zr(SO₄)₂·4H₂O, (7.100 grams, 20.0 mmol) were dissolved in H₂O (100 mL) in a round bottom flask. Then 0.6 grams of prepared iron oxide (Fe₃O₄) was dispersed in the solution and 1 mL formic acid was added. The mixture was heated at 98° C. under mechanical stirring and for 16 hours in an oil bath. After being cooled down to room temperature, the resulting powders were centrifuged and washed with water three times, then washed with methanol and dried at 60° C. Next, the product was incubated at 150° C. for 24 hours, and then treated in 2 vol % sulfuric acid in water (5 mL liquid per 0.100 grams) at 60° C. for 24 hours to restore the crystallinity after thermal activation. After cooling down to room temperature, the product was centrifuged and washed with water three times and methanol three times, respectively. Finally, the material was dried at 60° C. overnight. An example TEM image of the Fe₃O₄@Zr-BDC-NH₂-SO₄ MOF is shown in FIG. 5.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of making a magnetic metal organic framework material comprising:
modifying a surface of a magnetic iron oxide nanoparticle, producing a modified magnetic iron oxide nanoparticle;
adding a mixture of zirconium ions and aminoterephthalic acid to the modified magnetic iron oxide nanoparticle;
growing a metal organic framework on the modified magnetic iron oxide nanoparticle with the mixture of zirconium ions and aminoterephthalic acid, thereby producing the magnetic metal organic framework material;
heating the magnetic metal organic framework material; and
treating the magnetic metal organic framework material.

2. The method of claim 1, wherein the modifying the surface of the magnetic iron oxide nanoparticles comprises preparing the magnetic iron oxide nanoparticle with citric acid, thereby functionalizing the surface of the magnetic iron oxide nanoparticle with carboxylic acid.

3. The method of claim 1, wherein the zirconium ions are selected from a group consisting of Zr(SO₄)₂·4H₂O, ZrOCl₂·8H₂O, and combinations thereof.

4. The method of claim 1, wherein the zirconium ions and aminoterephthalic acid are present in a molar ratio ranging from 1:2 to 2:1.

5. The method of claim 1, wherein growing the metal organic framework further comprises heating the mixture of zirconium ions and aminoterephthalic acid with the modified magnetic iron oxide nanoparticle to a temperature in the range of 90 to 110° C.

6. The method of claim 5, wherein heating occurs over a time period of 12 to 24 hours.

7. The method of claim 1, wherein heating the magnetic metal organic framework material comprises heating at a temperature in the range of 110 to 200° C.

8. The method of claim 1, wherein treating the magnetic metal organic framework material comprises immersing and incubating with sulfuric acid, thereby adding a sulfate to the magnetic metal organic framework material

9. The method of claim 8, wherein the sulfuric acid has a concentration ranging from 1% v/v to 5% v/v.

10. A method of making a magnetic metal organic framework material comprising:
preparing a magnetic iron oxide nanoparticle;
modifying a surface of the magnetic iron oxide nanoparticle with citric acid, producing a modified magnetic iron oxide nanoparticle functionalized with a carboxylic acid;
adding a mixture of zirconium ions and aminoterephthalic acid to the modified magnetic iron oxide nanoparticle, wherein the zirconium ions are selected from a group consisting of Zr(SO₄)₂·4H₂O, ZrOCl₂·8H₂O, and combinations thereof and wherein the zirconium ions and aminoterephthalic acid are present in a molar ratio ranging from 1:2 to 2:1;
growing a metal organic framework on the modified magnetic iron oxide nanoparticle with the mixture of zirconium ions and aminoterephthalic acid, producing the magnetic metal organic framework material;
heating the magnetic metal organic framework material; and
treating the magnetic metal organic framework material, wherein treating comprises immersing and incubating with sulfuric acid in a concentration ranging from 1% v/v to 5% v/v, thereby adding a sulfate to the magnetic metal organic framework material.

11. The method of claim 10, wherein growing the metal organic framework further comprises heating the mixture of zirconium ions and aminoterephthalic acid with the modified magnetic iron oxide nanoparticle to a temperature in the range of 90 to 110° C.

12. The method of claim 10, wherein heating occurs over a time period of 12 to 24 hours.

13. The method of claim 10, wherein heating the magnetic metal organic framework material comprises heating at a temperature in the range of 110 to 200° C.
